(19) United States
(12) Patent Application Publication
(10) Pub. No.: US 2014/0041425 A1
(43) Pub. Date: Feb. 13, 2014

(54) Switch Restricting Assembly

(71) Applicant: Alfonso Pinzon, Rialto, CA (US)

(72) Inventor: Alfonso Pinzon, Rialto, CA (US)

(21) Appl. No.: 13/569,035

(22) Filed: Aug. 7, 2012

(51) Int. Cl. E05B 65/52

(52) U.S. Cl. 70/344

(57) ABSTRACT

A switch restricting assembly includes a mechanical joiner that is placed around a switch of an electronic device, such as a smart phone, to prevent the device from being turned on or off. In another embodiment, the assembly includes a case that surrounds the power button to prevent access. The joiner locks the case in position over the switch. The switch can also be a power switch, volume switch, a frequency switch, and a configuration switch. The joiner forms a physical barrier over the power switch for restricting access to the power switch. Also, the joiner can secure an external physical barrier, such as a case over the power switch to restrict access. A key releases the joiner from the power switch. Restricting access to the power switch allows a tracking device in the electronic device to remain powered on to facilitate recovery of stolen devices.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the invention generally relate to locking assemblies. More particularly, one or more embodiments of the invention relate to locking assemblies for portable electronic devices.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. By way of educational background, another aspect of the prior art generally useful to be aware of is that a lock is a mechanical or electronic joining device that is released by a physical object, such as a key, keycard, fingerprint, RFID card, or security token; or secret information, such as a keycode or password, or combination of more than one of these.

Typically, a SIM lock, network lock or subsidy lock is a capability built into mobile phones by mobile phone manufacturers. Network providers use this capability to restrict the use of these phones to specific countries and network providers.

The Global Positioning System (GPS) is a space-based satellite navigation system that provides location and time information in all weather, anywhere on or near the Earth, where there is an unobstructed line of sight to four or more GPS satellites. GPS is freely accessible to anyone with a GPS receiver. GPS receivers are integrated in cellular phones.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates a detailed perspective view of an exemplary switch restricting assembly, in accordance with an embodiment of the present invention;

FIG. 2 illustrates a detailed perspective view of an exemplary switch restricting assembly positioned over an electronic device, in accordance with an embodiment of the present invention;

FIG. 3 illustrates a detailed perspective view of an exemplary external physical barrier overlaying an exemplary electronic device, in accordance with an embodiment of the present invention; and

FIG. 4 illustrates a detailed perspective view of an exemplary mechanical joining portion securing an exemplary external physical barrier over an exemplary electronic device, in accordance with an embodiment of the present invention.

Unless otherwise indicated illustrations in the figures are not necessarily drawn to scale.

### DETAILED DESCRIPTION OF SOME EMBODIMENTS

Embodiments of the present invention are best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

Those skilled in the art will readily recognize, in light of and in accordance with the teachings of the present invention, that any of the foregoing steps may be suitably replaced, reordered, removed and additional steps may be inserted depending upon the needs of the particular application. Moreover, the prescribed method steps of the foregoing embodiments may be implemented using any physical and/or hardware system that those skilled in the art will readily know is suitable in light of the foregoing teachings. For any method steps described in the present application that can be carried out on a computing machine, a typical computer system can, when appropriately configured or designed, serve as a computer system in which those aspects of the invention may be embodied. Thus, the present invention is not limited to any particular tangible means of implementation.

The present invention will now be described in detail with reference to embodiments thereof as illustrated in the accompanying drawings.

There are various types of switch restricting assemblies 100 that may be provided by preferred embodiments of the present invention. In some embodiments, the switch restricting assembly 100 may provide a mechanical joining portion 102 to restrict access to a power switch 202 on an electronic device 200. However, in other embodiments, the power switch may include, without limitation, a volume switch, a frequency switch, and a configuration switch. In some embodiments, restricting access to the power switch may allow a global positioning system in the electronic device to remain powered on. Those skilled in the art will recognize that stolen electronic devices may be powered off to inhibit the global positioning system's tracking capabilities. In some embodiments, the mechanical joining portion may be configured to form a physical barrier over the power switch for restricting access to the power switch. However, in other embodiments, the mechanical joining portion may secure at least one external physical barrier 110 over the power switch to restrict access. The mechanical joining portion may include a mounting surface 104 for contacting and positioning onto the electronic device. The mechanical joining portion may further include an external surface 106 that provides an external cover for the power switch. In some embodiments, the mechanical joining portion may position over the power switch so that access to the power switch is restricted, and the electronic device is prevented from powering off. In this manner, a global positioning system receiver in the electronic device may be accessed for tracking the electronic device. In some embodiments, the tracking function may serve as a theft deterrent system, wherein a thief would be dissuaded from stealing an electronic device that included a traceable global positioning system receiver that is difficult to power off. In some embodiments, a release portion 108 may release the mechanical joining portion for accessing the power switch.

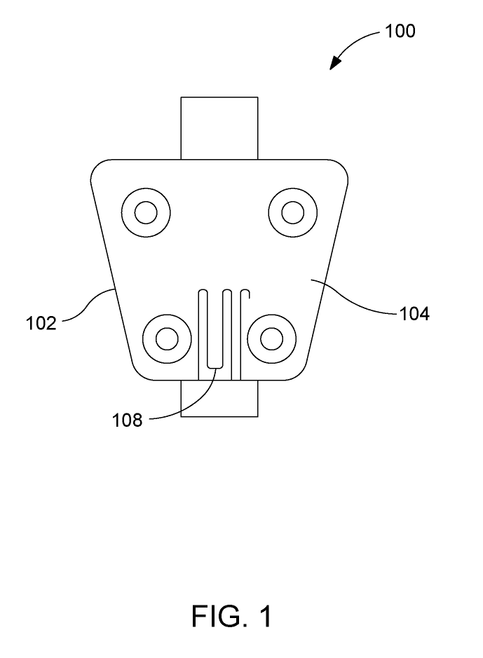

FIG. 1 illustrates a detailed perspective view of an exemplary switch restricting assembly, in accordance with an embodiment of the present invention. In some embodiments, the power switch restricting assembly may include the mechanical joining portion for restricting access to the power switch on the electronic device. In some embodiments, the mechanical joining portion may include a mounting surface 104 for contacting and positioning onto the electronic device. The mechanical joining portion may further include an external surface 106 that provides an external cover for the power switch. In some embodiments, the mechanical joining portion may be configured to form a physical barrier to the power switch. The mechanical joining portion may include a bracket that contours over an edge portion of the electronic device where the power switch is located. In other embodiments, the mechanical joining portion may hinge or swivel to mate with the electronic device, wherein the mounting surface of the mechanical joining portion overlays the power switch. However, in other embodiments, the mechanical joining portion may secure external physical barriers over the power switch. In some embodiments, each external physical barrier may include a case that contours a cellular phone in a configuration that covers the power switch. The mechanical joining portion may secure a pair of cases that join from a top portion and a bottom portion of the cellular phone. Suitable materials for fabricating the mechanical joining portion may include, without limitation, titanium, steel, alloy metals, silicone, rubber, plastic, and wood. In some embodiments, a release portion 108 may release the mechanical joining portion for accessing the power switch. The release portion may include, without limitation, a key, a keycard, a fingerprint, an RFID card, or a security token; or secret information, such as a key code or password, or combination of more than one of these. In one alternative embodiment, the mechanical joining portion may include a liquid adhesive that may be dispensed onto the power switch to prevent powering off. The liquid adhesive may be removed from the power switch with a separate chemical composition operable to dissolve the liquid adhesive, whereby the power switch may be released for powering off.

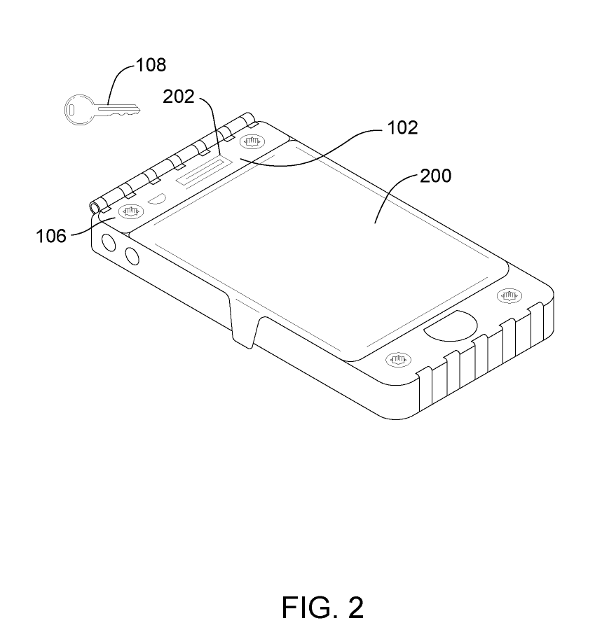

FIG. 2 illustrates a detailed perspective view of an exemplary switch restricting assembly positioned over an electronic device, in accordance with an embodiment of the present invention. In some embodiments, the mechanical joining portion may include a mounting surface for contacting and positioning onto the electronic device. The mechanical joining portion may hinge or swivel to mate with the electronic device, wherein the mounting surface of the mechanical joining portion overlays the power switch. In some embodiments, the electronic device may include, without limitation, a smart phone, an iPhone, an iPad, a laptop, and a portable electronic device. Those skilled in the art, in light of the present teachings will recognize that the power switch on most electronic devices may be located on the edge portion. The position of the power switch may dictate a plethora of configurations and shapes for the mechanical joining portion, including, without limitation, a bracket-shape, a U-shape, a clam-shape, and a simple bar.

In some embodiments, the mounting surface may provide sufficient grip to securely adhere the mechanical joining portion to the electronic device. However, the locking mechanism of the mechanical joining portion may provide sufficient tension or grip to secure the mounting surface to the electronic device. The shape and dimension of the mechanical joining portion may also be configured to secure the mechanical joining portion to the electronic device. In some embodiments, the external surface may also provide a handle for grasping the mechanical joining portion while attached to the electronic device. The external surface may also include decorative embodiments for enhancing or matching the design of the electronic device, including, without limitation, graphics, colors, text, logos, and various textures. Those skilled in the art, in light of the present teachings will recognize that the external surface may cover a substantial portion of the electronic device. In this manner, the mechanical joining portion or the external physical barrier may define the visual effect of the electronic device.

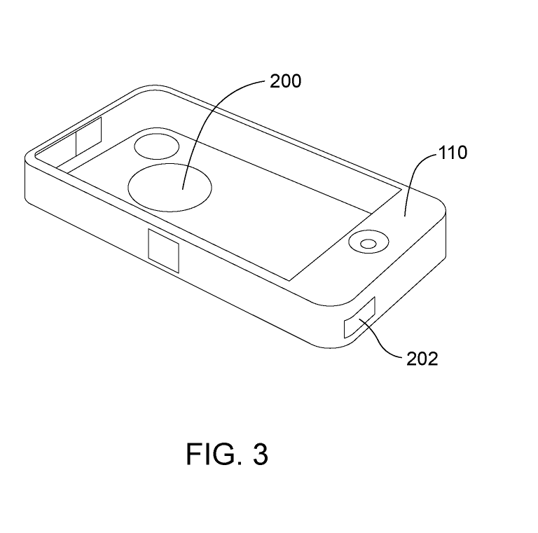

FIG. 3 illustrates a detailed perspective view of an exemplary external physical barrier overlaying an exemplary electronic device, in accordance with an embodiment of the present invention. In some embodiments, the mechanical joining portion may secure external physical barriers over the power switch. In some embodiments, each external physical barrier may include a case that contours a cellular phone in a configuration that covers the power switch. The mechanical joining portion may secure a pair of cases that join from a top portion and a bottom portion of the cellular phone. The mechanical joining portion may create sufficient tension on the external physical barrier, whereby removal is difficult, if not impossible. The cases may not only cover the power switch, but also cover other control members, buttons, and switches on the electronic device. In some embodiments, the external physical barrier may provide enhanced decorative features to the electronic device, including, without limitation, graphics, text, color, logos, and various textures.

In one alternative embodiment, the mechanical joining portion may include a simple titanium U-bracket that clamps a titanium bar directly over the power switch. In this embodiment, a simple mechanical key releases the clamp from the titanium bar. Those skilled in the art, in light of the present teachings will recognize that the electronic device, and by extension, the global positioning system may not function after the power source diminishes. In some embodiments, the external physical barrier may be efficacious for storing an additional power source. The additional power source may provide extended life to the electronic device so that additional time may be utilized to track the electronic device. In yet another embodiment, the additional power source may power an audio device that emits an alert sound if the electronic device has been misplaced or stolen. In some embodiments, the audio device may include, without limitation, a loud decibel speaker, a voice recording, and a siren. In one alternative embodiment, the audio device may be activated remotely by the owner of the electronic device, or may activate in periodic time intervals, whereby only the release portion may deactivate the audio device. In yet another alternative embodiment, the mechanical joining portion may restrict access to other buttons and switches on the electronic device, including, without limitation, volume, key pad, and nodes.

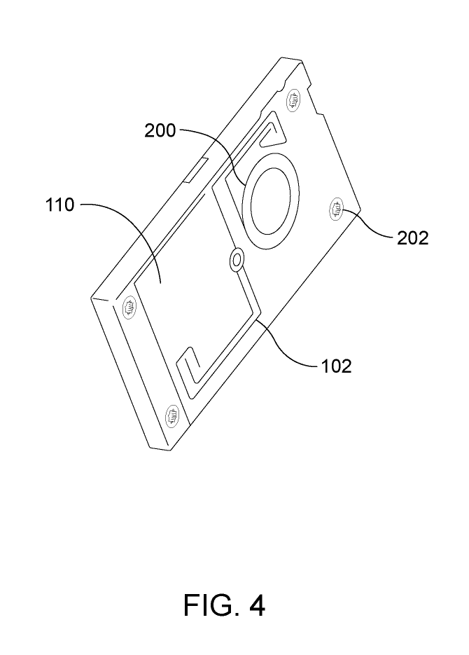

FIG. 4 illustrates a detailed perspective view of an exemplary mechanical joining portion securing an exemplary external physical barrier over an exemplary electronic device, in accordance with an embodiment of the present invention. In some embodiments, the mechanical joining portion may align along the longitudinal axis of the electronic device to secure the external physical barrier to both ends of the electronic device. In some embodiments, the external physical barrier may include a pair of cases that contour the electronic device, covering the power switch. The release portion may include a spring that exerts sufficient pressure on the mechanical joining portion so that the pair of cases securely joins over the electronic device and the power switch.

In one alternative embodiment, the switch restricting assembly may include a conductive substrate and a sensor electrode on the external surface of the mechanical joining portion, or the external physical barrier. The conductive substrate and the sensor electrode may be operable to detect the fingerprint of the owner of the electronic device, whereby the mechanical joining portion releases from the power switch. In this manner, the owner's finger may serve as the release portion. In yet another alternative embodiment, the power switch restricting assembly may include a computerized operating control system. The operating control system may include an input portion for inputting user access data. The operating control system may be operable to program instructions for the mechanical joining portion, including, without limitation, times and dates for powering on/off, functional capabilities of the electronic device, and monitoring, locking, and releasing the release portion.

Those skilled in the art, in light of the present teachings will recognize that the electronic device may include a tracking device that remains active while the electronic device is powered on; whereby, a stolen electronic device may be tracked more efficiently if the power switch is restricted to the on position. In yet another embodiment, the electronic device may be unintentionally powered on, thereby depleting the power source. By restricting the power switch to the off position, the power is saved.

All the features or embodiment components disclosed in this specification, including any accompanying abstract and drawings, unless expressly stated otherwise, may be replaced by alternative features or components serving the same, equivalent or similar purpose as known by those skilled in the art to achieve the same, equivalent, suitable, or similar results by such alternative feature(s) or component(s) providing a similar function by virtue of their having known suitable properties for the intended purpose. Thus, unless expressly stated otherwise, each feature disclosed is one example only of a generic series of equivalent, or suitable, or similar features known or knowable to those skilled in the art without requiring undue experimentation.

Having fully described at least one embodiment of the present invention, other equivalent or alternative methods of implementing a mechanical joining portion to restrict access to a power switch on an electronic device according to the present invention will be apparent to those skilled in the art. Various aspects of the invention have been described above by way of illustration, and the specific embodiments disclosed are not intended to limit the invention to the particular forms disclosed. The particular implementation of the mechanical joining portion to restrict access to a power switch on an electronic device may vary depending upon the particular context or application. By way of example, and not limitation, the mechanical joining portion to restrict access to a power switch on an electronic device described in the foregoing were principally directed to restrict access to the power switch of a cellular phone implementations; however, similar techniques may instead be applied to the key latch in an automobile, boat, or plane, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

What is claimed is:

1. A switch restricting assembly comprising:
a mechanical joining portion, said mechanical joining portion being configured to restrict access to a power switch, said mechanical joining portion comprising a mounting surface, said mounting surface being configured to engage an electronic device, said mechanical joining portion further comprising an external surface, said external surface being configured to provide a cover for said power switch;
a release portion, said release portion being operable to release said mechanical joining potion from said power switch; and
an external physical barrier, said external physical barrier being disposed to position between said power switch and said mechanical joining portion, said external physical barrier being configured to provide a barrier to said power switch.

2. The switch restricting assembly of claim 1, in which said mechanical joining portion comprises a lock.

3. The switch restricting assembly of claim 2, in which said mechanical joining portion is operable to cover said power switch.

4. The switch restricting assembly of claim 3, in which said mechanical joining portion comprises at least one hinge.

5. The switch restricting assembly of claim 4, wherein said mechanical joining portion is operable to pivot over an edge of said electronic device.

6. The switch restricting assembly of claim 5, in which said mechanical joining portion comprises a U-bracket, said U-bracket being configured to press a bar over said power switch.

7. The switch restricting assembly of claim 6, in which said mounting surface comprises a flat surface.

8. The switch restricting assembly of claim 7, wherein said mounting surface rests flush against said electronic device.

9. The switch restricting assembly of claim 8, in which said external surface comprises a handle, said handle being operable for grasping said mechanical joining portion.

10. The switch restricting assembly of claim 9, in which said external surface comprises a decorative design.

11. The switch restricting assembly of claim 10, in which said external physical barrier comprises a case.

12. The switch restricting assembly of claim 11, wherein said case covers a substantial portion of said electronic device.

13. The switch restricting assembly of claim 12, in which said external physical barrier comprises a power source.

14. The switch restricting assembly of claim 13, in which said release portion comprises a key.

15. The switch restricting assembly of claim 14, wherein said key comprises a spring, said spring being operable to press against said mechanical joining portion.

16. The switch restricting assembly of claim 15, wherein said power switch comprises an on/off switch.

17. The switch restricting assembly of claim 16, in which said electronic device comprises a communication device.

18. The switch restricting assembly of claim 17, wherein said communication device comprises a cellular phone.

19. A switch restricting assembly method comprising:
means for switching a power switch to an on position or an off position;
means for orienting a mounting surface to engage an electronic device;
means for positioning a mechanical joining portion over the power switch;
means for locking the mechanical joining portion with a release portion;
means for releasing the mechanical joining portion with the release portion; and
means for switching the power switch to an on position or an off position.

20. A switch restricting assembly consisting of:
a mechanical joining portion, said mechanical joining portion being configured to restrict access to a power switch, said mechanical joining portion comprising a U-bracket, said U-bracket being configured to press a bar over said power switch, said mechanical joining portion comprising a mounting surface, said mounting surface comprising a flat surface, said mounting surface being configured to engage an electronic device, said electronic device comprising a communication device, said mechanical joining portion further comprising an external surface, said external surface being configured to provide a cover for said power switch, said external surface comprising a handle, said external surface further comprising a decorative design;
a release portion, said release portion being operable to release said mechanical joining potion from said power switch, said release portion comprising a key; and
an external physical barrier, said external physical barrier being disposed to position between said power switch and said mechanical joining portion, said external physical barrier being configured to provide a barrier to said power switch, said external physical barrier comprising a case.
